(19) United States
(12) Patent Application Publication
(10) Pub. No.: US 2025/0214894 A1
(43) Pub. Date: Jul. 3, 2025

(54) METHODS FOR PRODUCTION OF PRECIPITATED CALCIUM CARBONATE (PCC), PCC PRODUCT, AND USES OF PCC

(71) Applicant: SPECIALTY MINERALS (MICHIGAN) INC., Plymouth, MI (US)

(72) Inventors: Chenhui JU, Suzhou (CN); Xinshu Wang, Suzhou (CN); Timothy S. Sammarco, Breinigsville, PA (US); Zhigang Chen, Mount Pleasant, SC (US); Zhaoshan Li, Shangdong (CN); Mark R. Daigle, Bethlehem, PA (US); Hai Lin, Suzhou (CN); Neil V. Pagotto, Bethlehem, PA (US)

(21) Appl. No.: 19/087,362

(22) Filed: Mar. 21, 2025

Related U.S. Application Data
(63) Continuation of application No. PCT/US2023/073876, filed on Sep. 11, 2023.
(60) Provisional application No. 63/414,864, filed on Oct. 10, 2022.

(51) Int. Cl. C04B 14/28; C01F 11/18

(52) U.S. Cl. CPC C04B 14/28; C01F 11/18; C01P 2004/03; C01P 2004/80

(57) ABSTRACT

A method for making precipitated calcium carbonate is provided. The process includes providing a suspension having calcium hydroxide and adding a processed lime mud to the suspension prior to the completion of carbonation to precipitate calcium carbonate.

### CROSS-REFERENCE

This application is a by-pass continuation of International Patent Application No. PCT/US2023/073876, filed Sep. 11, 2023, which claims the benefit of and priority to U.S. Provisional Application No. 63/414,864, filed Oct. 10, 2022, both applications are incorporated herein by reference in their entirety for all purposes.

### FIELD

The present inventions relate to methods for producing precipitated calcium carbonate (PCC). Moreover, the inventions relate to an aqueous suspension of PCC, the produced PCC, and products made from the produced PCC. More particularly, the inventions relate to a process for the production of PCC using processed lime mud.

### BACKGROUND

Precipitated calcium carbonate (PCC), having the chemical formula of CaCO₃, exists in three primary crystalline forms: calcite, aragonite, and vaterite. PCC can harbor many different polymorphs. The crystal habits can include scalenohedral, rhombohedral, hexagonal prismatic, cubic, and prismatic. PCC is prepared by introducing CO₂ into an aqueous suspension of calcium hydroxide (Ca(OH)₂), which is commonly referred to as “milk of lime”:

Ca(OH)₂+CO₂→CaCO₃+H₂O

PCC is used extensively in the paper industry. PCC is inexpensive and is used as a bulk enhancing material. PCC increases paper's brightness and opacity. Thus, PCC is considered an excellent filler material for paper and paperboard. PCC, however, can also affect paper “sizing,” which is a term commonly used in the art to quantify or describe the hydrophobic treatment of paper fiber. Poor paper sizing will cause poor printability (such as ink smudges) and the quality of printing to diminish. Fillers for paper such as PCC and ground calcium carbonate (GCC) can compete with paper fiber for sizing chemicals, resulting in reduction in sizing performance. Variables in PCC production can influence the specific surface area (SSA) of PCC particles, aggregates, or agglomerates. A large variation in SSA, for instance, can be attributed to variations the quality of the lime used. High amounts of impurities in the lime, such as silicon (Si) and magnesium (Mg), can increase PCC's SSA. Increases in PCC SSA can cause reduce paper sizing performance.

PCC's morphology can also influence paper sizing. A PCC filler with scalenohedral morphology aggregates into clusters, which in turn provides more porous structures. Such structures can consume sizing chemical, such as, for example, alkyl ketene dimer (AKD) and alkenyl succinic anhydride (ASA). AKD is the reactive synthetic sizing agent that is used in alkaline or neutral papermaking conditions to provide certain level of hydrophobicity to the paper. ASA is a basic or neutral type sizing agent and is used as an internal sizing chemical for paper mill. The consumption of the sizing chemicals by PCC's porous structure diminishes the effectiveness of the sizing chemicals by hindering the chemicals' ability to promote an acceptable level of paper sizing.

While PCC is a main filler and bulk-enhancing additive for paper, PCC can be combined with lime mud to be used as a paper filler. Lime mud is physically blended with PCC before application of the mixture to paper manufacturing. Lime mud is a by-product produced in pulp mills as part of the process that turns wood chips into pulp for paper. Accordingly, the by-product could be recycled back into paper to reduce waste. Additionally, lime mud is less expensive than PCC, and supplementing PCC with lime mud further reduces the cost of paper making.

However, the use of certain types of lime mud can cause poor paper sizing. Some types of lime mud include relatively high amounts of silicon (Si), including non-wood based lime mud (e.g., agricultural, bamboo, and straw pulp lime mud), and lime mud generated from pulping process (e.g., Alkaline Peroxide Mechanical Pulp (APMP) and Bleached Chemical Thermo-Mechanical Pulp (BCTMP)) where silicate/Si is used to stabilize bleaching chemicals. These amounts can be as high as 10+% SiO₂, but even lower amounts, such as 2% SiO₂, can adversely impact the quality of the paper. High Si amounts are converted into fine amorphous silica particles resulting in high SSA for the lime mud. When the lime mud's SSA is high, paper sizing can diminish to unacceptable levels. Fillers with high SSA levels consume more sizing chemicals, such as AKD and ASA.

The embodiments of the present inventions are intended to address, inter alia, the above problems by producing PCC and lime mud filler materials of suitable SSA and morphology to be used with paper for improved sizing and printability.

### SUMMARY

In accordance with one aspect of the present inventions, a process for producing a suspension of precipitated calcium carbonate (PCC) is provided. The process can comprise (a) adding a suspension including processed lime mud to a suspension including the calcium hydroxide; and (b) carbonating the suspension including the processed lime mud and the calcium hydroxide to form a resultant suspension including PCC. The processed lime mud can have a weight median diameter d₅₀ of at least 0.3 μm. The processed lime mud can have a weight median diameter d₅₀ of 0.3 μm to 10 μm. In accordance with one embodiment, the total amount of the processed lime mud used in the process can be in an amount ranging from 0.3 wt % to 80 wt % based on a total weight of dry PCC to be prepared. The lime mud used to make the processed lime mud can be a by-product of alkali recovery in pulping and papermaking. In one embodiment, a total amount of the suspension including the processed lime mud is added to the suspension including the calcium hydroxide prior to initiation of step (b) of carbonating the suspension. In one embodiment, step (a) of adding the suspension including the processed lime mud starts prior initiation of the carbonating step (b), continues during the carbonating step (b), and ends on or prior to a pH of a reaction content of carbonating step (b) reaching a value of 9 or 10. In one embodiment, step (a) of adding the suspension including the processed lime mud continues during a part of the carbonating step (b) and ends prior to the ending of the carbonating step (b). The processed lime mud can be made by a process comprising: (a) providing an aqueous suspension of lime mud; (b) dewatering the lime mud suspension to produce dewatered lime mud solids; (c) washing the dewatered lime mud solids and producing a washed lime mud suspension; (d) screening the washed lime mud suspension to remove lime mud solids of a selected size and/or grit particles out from the washed lime mud suspension; (e) milling the screened lime mud suspension; and (f) neutralizing the milled lime mud suspension with a nonmetal oxide containing material to produce the processed lime mud. The process can also include hydrating lime to form the suspension including calcium hydroxide. The carbonating step (b) can grow the PCC crystals on processed lime mud crystal clusters.

In accordance with another aspect of the present inventions, a method for making a filler comprising precipitated calcium carbonate (PCC) is provided. The method comprises (a) combining constituents comprising calcium oxide and water to prepare a slurry comprising calcium hydroxide; (b) supplying a processed lime mud to the slurry comprising the calcium hydroxide to form a resultant comprising the processed lime mud and the calcium hydroxide; and (c) conducting a carbonation process of the resultant comprising the processed lime mud and the calcium hydroxide to form a suspension comprising PCC. The precipitated calcium carbonate can encapsulate processed lime mud particles or crystal clusters. In one embodiment, the supplying the processed lime mud ends before starting the carbonation process. In one embodiment, the conducting of the carbonation process comprises adding a carbon dioxide generating material to the resultant comprising the processed lime mud and the calcium hydroxide, and the method additionally comprises ending the supplying of the processed lime mud to the slurry prior to the adding of the carbon dioxide generating material to the resultant. In one embodiment, the conducting of the carbonation process comprises adding a carbon dioxide generating material to the resultant comprising the processed lime mud and the calcium hydroxide, and wherein the supplying of the processed lime mud continues during a part of the carbonation process. In one embodiment, the supplying of the processed lime mud continues during the carbonation process and ends on or before pH reaches a value of 9 or, alternatively, 10. The method can additionally comprise: (d) separating the precipitated calcium carbonate and processed lime mud from the suspension; and (e) drying the separated solids to form dry precipitated calcium carbonate and processed lime mud composites. The total amount of processed lime mud used for the method can be in an amount ranging from 0.3 wt % to 80 wt % based on a total weight of dry PCC to be prepared. The processed lime mud can be made by a process comprising: (a) providing an aqueous suspension of lime mud that is a by-product of alkali recovery in pulping and papermaking; (b) dewatering the lime mud suspension to produce dewatered lime mud solids; (c) washing the dewatered lime mud solids and producing a washed lime mud suspension; (d) screening the washed lime mud suspension to remove lime mud solids of a selected size and/or grit particles out from the washed lime mud suspension; (e) milling the screened lime mud suspension; and (f) neutralizing the milled lime mud suspension with a nonmetal oxide containing material to produce the processed lime mud. The processed lime mud can have a weight median diameter d₅₀ in the range of 0.3 μm to 10 μm. In accordance with another aspect of the present inventions, a method for making precipitated calcium carbonate is provided. The method can comprise: (a) hydrating calcium oxide to form a slake; (b) adding an aqueous suspension of processed lime mud to the slake; and (c) adding a carbon dioxide generating material to form an aqueous suspension of precipitated calcium carbonate coated on the processed lime mud, wherein (i) the addition of the aqueous suspension of the processed lime mud starts and ends before the start of the addition of the carbon dioxide generating material, or (ii) the addition of the aqueous suspension of the processed lime mud starts before the start of the addition of the carbon dioxide generating material, continues during the addition of the carbon dioxide generating material, and ends on or before pH of a reaction content of step (c) reaches a value of 9 or 10, or (iii) the addition of the aqueous suspension of the processed lime mud and the addition of the carbon dioxide generating material start at the same time and the addition of the aqueous suspension of the processed lime mud ends on or before pH of a reaction content of step (c) reaches a value of 9 or 10. The method can additionally comprise: (d) separating the precipitated calcium carbonate and processed lime mud from the aqueous suspension; and (e) drying the separated solids to form dry precipitated calcium carbonate at least partially coated on the processed lime mud. The total amount of the processed lime mud used can be greater than 0.3 wt % and less than 80 wt % based on the total weight of the dry precipitate calcium carbonate. The processed lime mud can have a weight median diameter d₅₀ in the range of 0.3 μm to 10 μm.

In accordance with another aspect of the present inventions, a paper product is provided comprising the precipitated calcium carbonate and processed lime mud made from the processes of the present inventions.

In accordance with another aspect of the preset inventions, a filler material is provided comprising precipitated calcium carbonate grow on processed lime mud particles made from the processes of the present inventions.

### BRIEF DESCRIPTION OF THE DRAWINGS

FIG. 1 illustrates the process of making precipitated calcium carbonate in accordance with one embodiment of the invention.

FIG. 2 illustrated the process of making processed lime mud suspension in accordance with one embodiment of the invention.

FIG. 3 is a graph of the Cobb value versus specific surface area (SSA) of Example 1.

FIG. 4 illustrates a comparative process of making precipitated calcium carbonate for Example 2.

FIG. 5 is a graph of Cobb value versus Ash percentage of Example 2.

FIG. 6 is the morphology of the sample of Example 2.

FIG. 7 is the morphology of the sample of Example 2.

FIG. 8 is the morphology of the sample of Example 2.

FIG. 9 is the morphology of the sample of Example 2.

### DESCRIPTION

As used herein, precipitated calcium carbonate (PCC) takes its ordinary chemistry definition having a chemical formula of CaCO₃. PCC has three primary crystalline forms: calcite, aragonite and vaterite. It can also include a variety of different polymorphs or crystal habits for each of these crystalline forms. For the embodiments of the present inventions, the crystal habit can preferably be a scalenohedral (S-PCC).

As used herein, calcium hydroxide takes its ordinary chemistry definition having a chemical formula of Ca(OH)₂. Calcium hydroxide has traditionally been referred to as “slaked lime” or “milk of lime.” Slake, slaked lime, milk of lime, and slurry having calcium hydroxide are terms that are used interchangeably herein. Slaked lime is produced when calcium oxide or quicklime is mixed or slaked with water, or is hydrated. Calcium hydroxide has many other names including hydrated lime, caustic lime, builders' lime, and pickling lime. The slake can be a calcium hydroxide slurry, such as an aqueous calcium hydroxide suspension and can, for example, have a solids content of less than 40% by weight.

As used herein, calcium oxide takes its ordinary chemical definition having a chemical formula of CaO. Calcium oxide is commonly known as lime or quicklime and is an alkaline substance.

As used herein, calcium oxide containing compound or material is a material having at least 40 wt % calcium oxide based on the total weight of the material. Preferably, the content would be at least 70 wt %, and more preferably at least 90%.

As used herein, a slurry is a mixture of solids suspended in liquid, usually water. The suspension can include insoluble solids, water, and optionally additives.

As used herein, lime mud takes its ordinary chemical definition and can be, for example, a by-product produced in pulp mills as part of the process that turns wood chips into pulp for paper. The lime mud can be the by-product of alkali recovery in pulping and papermaking. A pulp mill processes or “cooks” wood chips with an alkaline pulping liquor comprised of sodium hydroxide or a blend of sodium hydroxide and sodium sulfide to extract the wood fiber used to make paper. During the process, sodium hydroxide is converted to sodium carbonate. The pulp mill then adds calcium oxide or quicklime to convert the sodium carbonate back to sodium hydroxide in order to use it again. In the process, calcium carbonate is formed. Calcium carbonate is the major component of lime mud. Although lime mud is largely calcium carbonate, it can also contain, for example, silica, magnesium carbonate and traces of nitrogen, calcium, potassium oxide, phosphorus pentoxide, magnesium, sulfur, boron, copper, and/or zinc. Lime mud can be synthesized by lime and water and Na₂CO₃. The main chemical reactions occurred during the caustic process of paper-making lime mud are as follows:

CaO+H₂O→Ca(OH)₂

Ca(OH)₂+Na₂CO₃→2NaOH+CaCO₃↓

As used herein, processed lime mud is lime mud that has been subjected to treatment steps. The treatment steps can include, and are not limited to, for example, dewatering, washing, screening, milling, and/or neutralizing.

As used herein, carbon dioxide generating compound or material can include, and is not limited to, for example, gaseous carbon dioxide, liquid carbon dioxide, solid carbon dioxide, a gas or liquid containing carbon dioxide (e.g., Na₂CO₃, K₂CO₃, etc.), pure gaseous carbon dioxide, and a flue gas containing carbon dioxide. The carbon dioxide generating compound can be a gaseous mixture of carbon dioxide and air or carbon dioxide and nitrogen.

As used herein, the carbonation process (or carbonating) refers to the process of converting calcium hydroxide into PCC. The conversion can take place by adding or supplying a quantity or volume (e.g., kg CO₂/minute per kg of dry Ca(OH)₂) of carbon dioxide generating compound to the slake in a reaction vessel. The completion of the carbonation process can extend after the completion of the addition of the carbon dioxide generating compound and the addition of the carbon dioxide generating compound can be continuous or intermittent.

As used herein, reaction content is defined as the content included in the reaction vessel during the carbonation process, such as the suspension being carbonated. The content can include, but is not limited to the aqueous phase, the carbon dioxide generating compound, the calcium hydroxide slurry, the processed lime mud, already formed precipitated calcium carbonate, and/or additives that may have been added during the process. For example, when referring to the pH of the suspension or the carbonation process, this is intended to mean the pH of the reaction content at the time the measurement is taken.

As used herein, an aqueous suspension refers to a system where the liquid phase comprises, consists essentially of, or consists of water. The term can encompass water in combination with minor amounts of a water-miscible organic solvent, such as methanol, ethanol, acetone, acetonitrile, tetrahydrofuran, and combinations thereof.

As used herein, specific surface area or SSA is determined by BET method (Brunauer, Emmet, Teler, ISO 9277) as is well known in the art.

As used herein, particle size refers to weight-based distribution of particle size dₓ. The value of dₓ represents the diameter relative to which x % by weight of the particles have diameters less than dₓ. Particle size values disclosed herein are measured by sedimentation method, such as Sedigraph particle size analysis, as is well known in the art.

As used herein, solid content of a liquid composition refers to the amount of solid material, in weight %, remaining after all of the solvent and/or water has been removed and/or evaporated.

As used herein, coat, coating, or coated can mean a substrate being covered, fully or partially, by another material. For example, when particle A is referred to as being coated by compound B, it means that compound B fully or at least partially covers the surface of particle A and that compound B can be either physically attached and/or chemically bonded to particle A.

As used herein, the singular forms “a”, “an,” and “the” are intended to include the plural forms and plural is intended to include singular, unless the context clearly indicates otherwise (such as, for example, with the use of the term “one” or “plurality”). For example, reaction content can include more than one content.

As used herein, the term “and/or” includes one or any combinations of one or more of the associated listed items.

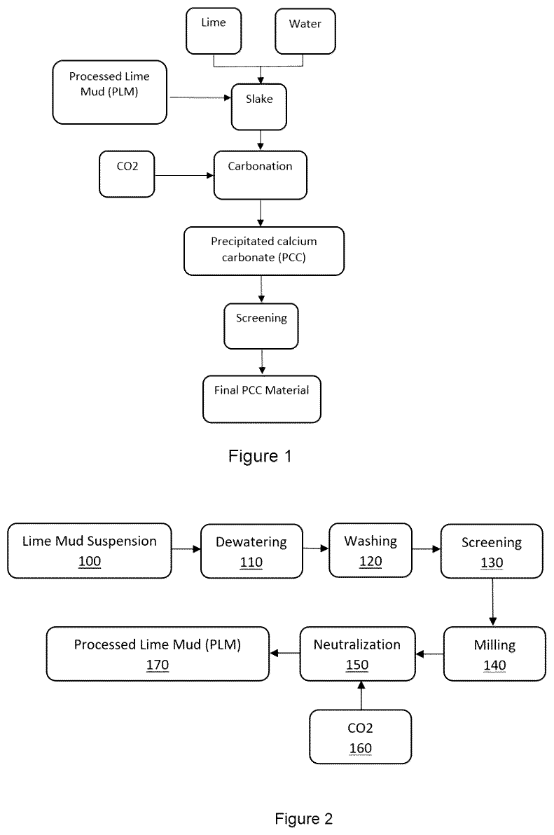

FIG. 1 illustrates an embodiment of the process for making precipitated calcium carbonate (PCC). Calcium oxide containing material or quicklime is added to water or is hydrated to form a slake or a slurry having calcium hydroxide. The slake can be screened to remove particles of undesirable sizes. Before the initiation of the carbonation process by introduction of a carbon dioxide generating material, an aqueous suspension comprising (or consisting essentially of, or consisting of) processed lime mud is added to the slake or slurry. The processed lime mud can be added in dry form.

In one embodiment, the addition of the suspension of the processed lime mud (or in dry form) can start and end before the start of the carbonation process or the addition of the carbon dioxide generating material. That is, before the start of the carbonation process or the addition of the carbon dioxide generating material, all of the processed lime mud is added to the slake and no processed lime mud is added at any point during the carbonation process. The addition or supply of processed lime mud and/or carbon dioxide generating material can be continuous or intermittent.

In one embodiment, the addition of the processed lime mud (e.g., suspension or in dry form) starts before the start of the carbonation process or addition of the carbon dioxide generating material, continues during a part of the carbonation process or addition of the carbon dioxide generating material, and ends before the termination of the carbonation process or the termination of the addition of the carbon dioxide generating material. The addition or supply of processed lime mud and/or carbon dioxide generating material can be continuous or intermittent. In one embodiment, the addition of the processed lime mud is completely discontinued on or before the pH of the reaction content reaches a pH of 10, or alternatively 9 and no more processed lime mud is added after the pH reaches 10, or alternatively 9. The pH value of the reaction content becomes smaller from the start to the end of the carbonation process. For example, the pH value can be 12-13 at the start of the carbonation process and 7-8 at the end of the carbonation process.

In one embodiment, the addition of the processed lime mud (e.g., suspension or in dry form) and the initiation of the carbonation process or the start of the addition of the carbon dioxide containing material start at the same time, and the addition of the processed lime mud ends before the end of the carbonation process or the termination of the addition of the carbon dioxide containing material. The addition or supply of processed lime mud and/or carbon dioxide generating material can be continuous or intermittent. In one embodiment, the addition of the processed lime mud is completely discontinued on or before the pH of the reaction content reaches a pH of 10, or alternatively 9, and no more processed lime mud is added after the pH reaches 10, or alternatively 9. Again, as noted above, the pH value of the reaction content becomes smaller from the start to the end of the carbonation process. For example, the pH value can be 12-13 at the start of the carbonation process and 7-8 at the end of the carbonation process.

The carbonation process can produce an aqueous suspension comprising PCC and processed lime mud. The process can produce a composite or complex of PCC and processed lime mud. The PCC crystals can grow on the processed lime mud particles, cores, or crystal clusters. The processed lime mud can be coated with the PCC. The method of the embodiments of the present invention can also include separating the PCC from the resulting aqueous suspension and drying the PCC and processed lime mud. The separating, filtering, and drying steps can be used to form dry PCC and processed lime mud (e.g., processed lime mud coated or encapsulated with PCC). The total amount of the processed lime mud that is used in the process, or is added to the slake, can be in an amount ranging from greater than 0.3 wt % to less than 80 wt %, preferably from 1.0 wt % to 40 wt %, based on the total weight of the dry PCC that is intended to be produced, or the solid PCC content that is intended to be produced, or the dry calcium carbonate containing material that is intended to be produced (i.e., a composite or complex comprising (consisting essentially of, or consisting of) processed lime mud and PCC).

FIG. 2 is an exemplary embodiment for the production of the processed lime mud. In step 100 an aqueous suspension of lime mud is provided. In step 110 the suspension is dewatered for producing dewatered lime mud solids. In step 120 the dewatered lime mud solids can be washed. The lime mud solids can also be diluted into the washed lime suspension. In step 130 the washed lime mud suspension is subjected to a screening process to remove lime mud solids of a selected size and/or grit particles out from the washed mud suspension. In step 140, the screened lime mud suspension is milled. In step 150 the milled lime mud suspension is neutralized with a nonmetal oxide containing material to produce the processed lime mud. The nonmetal oxide containing material can include CO₂, SO₂, SO₃, and mixtures thereof. The nonmetal oxides may be introduced to the lime mud suspension as a solid, liquid, or gas. An aqueous suspension of processed lime as an additive (e.g., precipitation additive for PCC) is produced, where the processed lime mud has a weight median diameter d₅₀ of at least 0.3 μm, preferably 0.3 μm to 10 μm.

It is further understood that a variety of additives can be added prior to or after the carbonation process. For example, the additives can be added to the milk of lime. The additive can be, for example a slaking additive or a precipitation additive. Examples of additives include sugar, citric acid, potassium, sodium, and other additives well known in the art. Moreover, the processes of the present inventions can be performed in batch, semi-batch, or continues mode. The continuous mode can be in a continuous tube reactor or several separate carbonators (pH of suspension is gradually reduced from the first carbonator to the last carbonator).

The fillers and additives made by the processes of the present inventions can be used for paper (herein intended to include paperboard and all paper products). The filler and additives made by the processes of the present inventions can also be used for consumable goods including, but not limited to coatings, paints, rubbers, plastics, polymers, building materials, ink, food, cosmetics, agricultural products, drugs, and pharmaceuticals.

The addition of processed lime mud to the slake, in accordance with the embodiments of the present inventions, can produce a filler material comprising (or consisting of, if other fillers are not added) a composite or complex of processed lime mud with PCC. The processed lime mud particles, cores, or crystal clusters can be coated with PCC. The PCC preferably has a scalenohedral crystal structure (S-PCC). The processes of the present inventions can allow for the PCC to be synthesized and grown on the processed lime mud particles during the carbonation process. The precipitated calcium carbonate crystals grow with processed lime mud particles, cores, or clusters and encapsulate processed lime mud particles, cores, or clusters. The precipitated calcium carbonate can coat the processed lime mud particles. The SSA of the produced filler material, that is the processed lime mud coated with PCC, can be reduced by as much as 45% as compared to the SSA of the blend of processed lime mud and PCC when the same quantity, type, and size of lime mud is blended with comparable PCC after the carbonation process.

For example, the SSA of 25% processed lime mud coated with 75% PCC is less than SSA of 25% processed lime mud blended, after the carbonation process, with 75% PCC. The addition of processed lime mud into the slake, in accordance to the methods of the present inventions, provides an unexpected effect of reducing SSA as compared to physically blending the same two components after each component is made after the carbonation process. The processes of the inventions also produce PCC (e.g., S-PCC) having less porosity and a more solid structure. Lower porosity prevents or minimize the consumption of sizing chemicals (e.g., AKD, ASA, and rosin) that are added during paper manufacturing. Lower filler SSA improves paper quality by enhancing paper sizing. Enhanced paper sizing reduces the degree of which ink can smudge on the surface of the paper. The processes of the present inventions allow for the use of lower cost and quality lime mud to supplement the PCC filler as it is believed that the higher quantities of impurities in the lower quality lime mud will not significantly affect the reduced SSA and PCC porosity achieved by the methods of the present inventions.

### EXAMPLES

### Example 1

### Raw Materials:

Lime A was collected from lime silo of Specialty Minerals Inc. XRF analysis showed lime A has high Si (4.8% in the form of SiO₂).

Processed lime mud (PLM) is manufactured from non-wood based lime mud, which was generated from Caustic/APMP (Alkaline Peroxide Mechanical Pulp) pulping process containing a large amount of Si, where silicate/Si is used to stabilize bleaching chemicals properties, resulting in high SSA. The properties of PLM were shown as “PLM” at Table 1.

### Lab Process:

1. Preparation of an aqueous suspension of precipitated calcium carbonate (PCC) control.

### PCC Control was Synthesized in Lab by Lime a Based on Standard Lab Synthesis Process:

Slake was prepared by using Lime A and water with a lime to water ratio of 1:7. Carbonation was carried out in a 4 liter laboratory reactor, equipped with a stirrer agitation at 1250 rpm. Gas was 15% CO₂ and 85% Air. The carbonation was started at 50° C. by CO₂ injection until pH reached to 7.5. CO₂ was paused for 5 min then the slurry was re-carbonated to pH 7.5. The PCC control's properties were shown as “PCC1” of Table 1.
2. Preparation of mixed PCC control with PLM filler (comparative process). Mixed PCC control with PLM filler was made as shown by the process of FIG. 4. The mixing ratio of PCC1 and PLM filler was 80:20 based on dry weight. The mixed PCC1-PLM properties were shown as “Mixed 20PLM80PCC1” of Table 1.
3. Preparation of an aqueous suspension of PCC filler by the process of FIG. 1.

PCC filler of an embodiment of the present invention was synthesized in lab by Lime A and PLM filler. Slake was prepared by using Lime A and water with a lime to water ratio of 1:7. Carbonation was carried out in a 4 liter laboratory reactor, equipped with a stirrer agitation at 1250 rpm. Gas was 15% CO₂ and 85% Air. The carbonation was started at 50° C. by CO₂ injection until pH reached to 7.5, CO₂ was paused for 5 min then the slurry was re-carbonated to pH 7.5. Prior to carbonation, 20 wt. % of the PLM filler, based on the final total weight of calcium carbonate, was added as additive to the slake (i.e., prior to the initiation of the carbonation). The synthesized new PCC's properties were shown as “NPCC” of Table 1.

TABLE 1
Characteristics of the lab experimental fillers

| | | | Mixed | |
|---|---|---|---|---|
| | PLM | PCC1 | 20PLM80PCC1 | NPCC |
| Horiba D90 (μm) | 10.7 | 5.3 | 5.9 | 6.3 |
| Horiba D50 (μm) | 3.9 | 2.8 | 3.0 | 3.3 |
| Horiba D20 (μm) | 2.0 | 1.8 | 1.8 | 2.0 |
| Horiba D10 (μm) | 1.4 | 1.3 | 1.3 | 1.5 |
| SSA (m2/g) | 16.1 | 14.9 | 16.6 | 10.2 |
| ISO Dry Brightness | 86.3 | 88.9 | 88.7 | 88.9 |
| R457 | | | | |
| ISO Dry Color-b | 3.7 | 3.1 | 3.2 | 3.0 |

From Table 1, PLM has high SSA (16.1 m²/g). PCC1 is manufactured using low-quality lime with more impurities resulting in high SSA (14.9 m²/g). Finally, the SSA of Mixed 20PLM80PCC1 has high SSA (16.6 m²/g). With the same ratio of PLM, the SSA of NPCC was reduced (10.2 m²/g), even lower than that of PCC1. This method can reduce the negative impact from high SSA of PLM and also improve PCC quality.

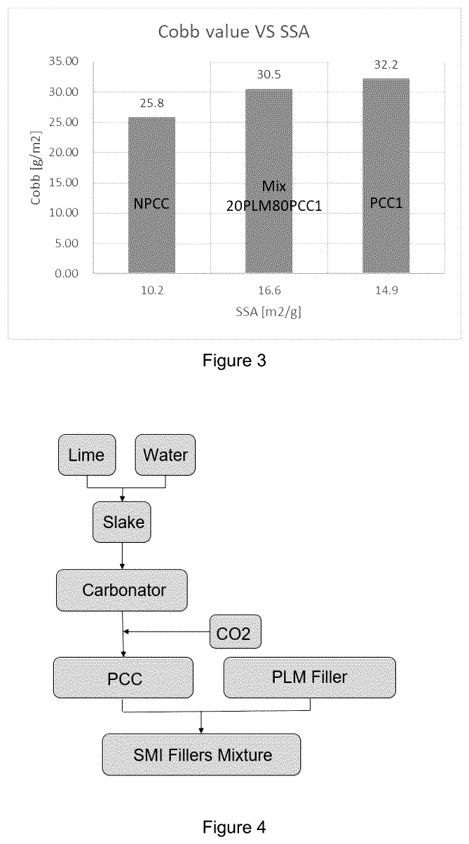

PCC1, Mixed 20PLM80PCC1, and NPCC were used to do handsheet sizing tests. The results are shown by FIG. 3. Cobb value of NPCC has the lowest value, which can enhance paper sizing.

### Example 2

Slake was prepared by using Lime B and water with a lime to water ratio of 1:7. Split the slake into 2 carbonators to make the plant trial using the slake with the same quality.

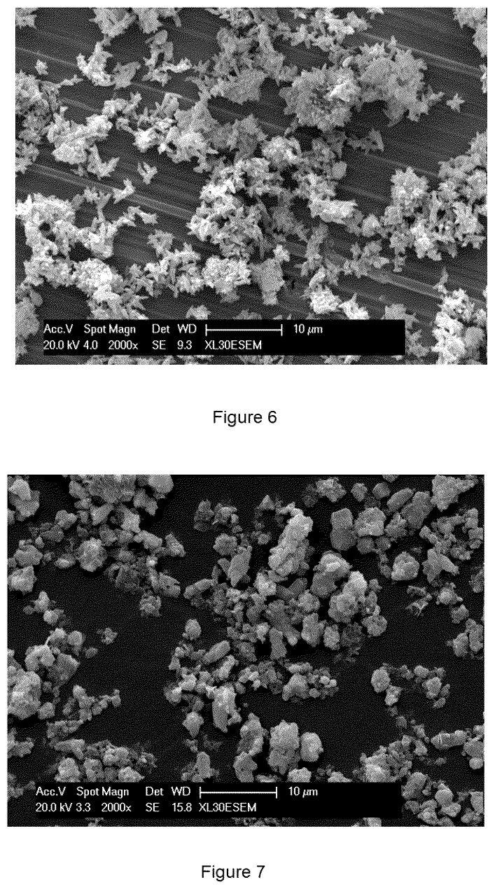

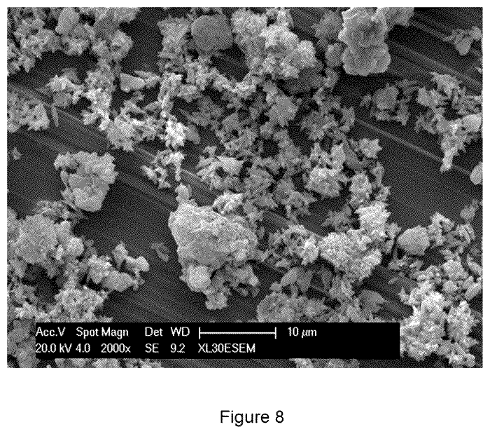

FIG. 4 route-comparative route: At the carbonator, slake was carbonated to make PCC control, then the PCC control was blended with PLM filler, the ratio of PLM filler was 36% based on the final total weight of calcium carbonate. The properties of the prepared PCC control/PLM Filler mixture are shown as PCC1/PLM/Mixed 36PLM64PCC1 in Table 2. The morphology of PCC1 is shown by FIG. 6, the morphology of PLM is shown by FIG. 7, and the morphology of Mixed 36PLM64PCC1 is shown by FIG. 8.

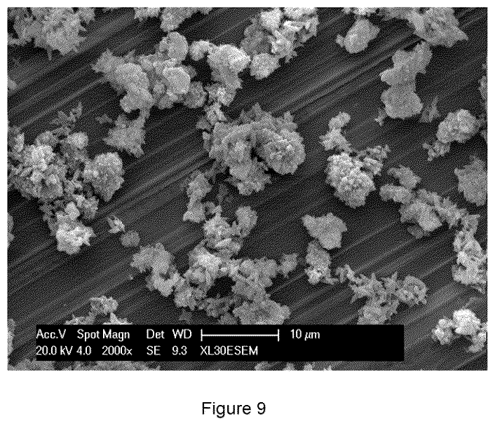

FIG. 1 route: Prior to carbonation, slake was mixed with PLM filler. The ratio of PLM filler was 36% based on the final total weight of calcium carbonate. Carbonation starts on the mixed slake and PLM filler to make New PCC filler. The properties of plant prepared New PCC filler are shown as “NPCC” by Table 2. The morphology of NPCC is shown by FIG. 9.

TABLE 2
Characteristics

| | | ISO | | Horiba | Horiba | Horiba | Horiba | Horiba | Sedigraph | Sedigraph | Sedigraph | Sedigraph | Sedigraph |
|---|---|---|---|---|---|---|---|---|---|---|---|---|---|
| | SSA | R457 | b | D98 | D95 | D90 | D50 | D20 | D98 | D95 | D90 | D50 | D20 |
| Sample list | [m2/g] | [%] | — | [um] | [um] | [um] | [um] | [um] | [um] | [um] | [um] | [um] | [um] |
| PCC1 | 8.3 | 88.7 | 2.8 | 8.3 | 6.9 | 5.9 | 3.3 | 2.1 | 7.7 | 6.1 | 5.0 | 2.0 | 1.0 |
| PLM | 13.6 | 85.9 | 4.0 | 11.3 | 9.3 | 7.7 | 3.9 | 2.3 | 16.6 | 10.6 | 7.8 | 3.0 | 1.4 |
| Mixed | 10.6 | 88.9 | 3.0 | 7.6 | 6.5 | 5.7 | 3.3 | 2.1 | 11.8 | 7.7 | 5.8 | 2.4 | 1.1 |
| 36PLM64PCC1 | | | | | | | | | | | | | |
| NPCC | 8.3 | 90.3 | 2.5 | 10.4 | 8.7 | 7.4 | 4.1 | 2.6 | 12.8 | 8.6 | 6.4 | 2.9 | 1.5 |

From Table 2, compared with standard route (Mixed 36PLM64PCC1), SSA of new route (NPCC) is reduced by 22%, from 10.6 m²/g to 8.3 m²/g. SSA of new route (NPCC) has been reduced to the same level of PCC1.

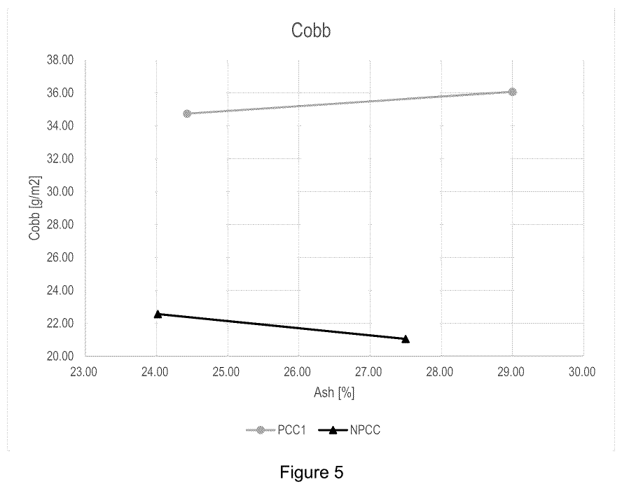

PCC1 and NPCC was used to do handsheet sizing tests. The results are shown in FIG. 5. Cobb value of NPCC was reduced resulting in improved sizing. From the morphology comparison, NPCC has more solid core structure and PCC1 has a porous structure.

While several particular forms, variations, and embodiments of the inventions have been illustrated and described, it will also be apparent that various modifications can be made without departing from the scope of the inventions. It is also contemplated that various combinations or sub-combinations of the specific features and aspects of the disclosed embodiments can be combined with or substituted for one another in order to form varying modes of the inventions.

What is claimed is:

1. A process for producing a suspension of precipitated calcium carbonate (PCC), comprising:
(a) adding a suspension including processed lime mud to a suspension including the calcium hydroxide; and
(b) carbonating the suspension including the processed lime mud and the calcium hydroxide to form a resultant suspension including PCC.

2. The process of claim 1, wherein the processed lime mud has a weight median diameter d₅₀ of at least 0.3 μm.

3. The process of claim 1, wherein the processed lime mud has a weight median diameter d₅₀ of 0.3 μm to 10 μm.

4. The process of claim 1, wherein a total amount of the processed lime mud used in the process is an amount ranging from 0.3 wt % to 80 wt % based on a total weight of dry PCC to be prepared.

5. The process of claim 1, wherein a lime mud used to make the processed lime mud is a by-product of alkali recovery in pulping and papermaking.

6. The process of claim 1, wherein a total amount of the suspension including the processed lime mud is added to the suspension including the calcium hydroxide prior to initiation of step (b) of carbonating the suspension.

7. The process of claim 6, further comprising producing a filler material including the processed lime mud coated with PCC, wherein a specific surface area of the filler material is reduced by 45% or more as compared to a specific surface area of a blend of the processed limed mud and PCC when blended after the carbonation process.

8. The process of claim 1, wherein step (a) of adding the suspension including the processed lime mud starts prior initiation of the carbonating step (b), continues during the carbonating step (b), and ends on or prior to a pH of a reaction content of carbonating step (b) reaching a value of 9 or 10.

9. The process of claim 1, wherein step (a) of adding the suspension including the processed lime mud continues during a part of the carbonating step (b) and ends prior to the ending of the carbonating step (b).

10. The process of claim 1, wherein the processed lime mud is made by a process comprising:
(a) providing an aqueous suspension of lime mud;
(b) dewatering the lime mud suspension to produce dewatered lime mud solids;
(c) washing the dewatered lime mud solids and producing a washed lime mud suspension;
(d) screening the washed lime mud suspension to remove lime mud solids of a selected size and/or grit particles out from the washed lime mud suspension;
(e) milling the screened lime mud suspension; and
(f) neutralizing the milled lime mud suspension with a nonmetal oxide containing material to produce the processed lime mud.

11. The process of claim 1, additionally comprising hydrating lime to form the suspension including calcium hydroxide.

12. The process of claim 1, wherein the carbonating step (b) grows PCC crystals on processed lime mud clusters.

13. A method for making a filler comprising precipitated calcium carbonate (PCC), the method comprising:
(a) combining constituents comprising calcium oxide and water to prepare a slurry comprising calcium hydroxide;
(b) supplying a processed lime mud to the slurry comprising the calcium hydroxide to form a resultant comprising the processed lime mud and the calcium hydroxide; and
(c) conducting a carbonation process of the resultant comprising the processed lime mud and the calcium hydroxide to form a suspension comprising PCC.

14. The method of claim 13, wherein a specific surface area of the filler material is reduced by 45% or more as compared to a specific surface area of a blend of the processed limed mud and PCC when blended after the carbonation process.

15. The method of claim 13, wherein the precipitated calcium carbonate encapsulates processed lime mud clusters.

16. The method of claim 13, wherein the supplying the processed lime mud ends before starting the carbonation process.

17. The method of claim 13, wherein the conducting of the carbonation process comprises adding a carbon dioxide generating material to the resultant comprising the processed lime mud and the calcium hydroxide, and the method additionally comprises ending the supplying of the processed mud to the slurry prior to the adding of the carbon dioxide generating material to the resultant.

18. The method of claim 13, wherein the conducting of the carbonation process comprises adding a carbon dioxide generating material to the resultant comprising the processed lime mud and the calcium hydroxide, and wherein the supplying of the processed lime mud continues during a part of the carbonation process.

19. The method of claim 13, wherein the supplying of the processed lime mud continues during the carbonation process and ends on or before pH reaches a value of 9 or 10 for the carbonation process.

20. The method of claim 13, additionally comprising:
(d) separating the precipitated calcium carbonate and processed lime mud from the suspension; and
(e) drying the separated solids to form dry precipitated calcium carbonate and processed lime mud composites.

21. The process of claim 13, wherein a total amount of processed lime mud used for the method is in an amount ranging from 0.3 wt % to 80 wt % based on a total weight of dry PCC to be prepared.

22. The method of claim 13, wherein the processed lime mud is made by a process comprising:
(a) providing an aqueous suspension of lime mud that is a by-product of alkali recovery in pulping and papermaking;
(b) dewatering the lime mud suspension to produce dewatered lime mud solids;
(c) washing the dewatered lime mud solids and producing a washed lime mud suspension;
(d) screening the washed lime mud suspension to remove lime mud solids of a selected size and/or grit particles out from the washed lime mud suspension;
(e) milling the screened lime mud suspension; and
(f) neutralizing the milled lime mud suspension with a nonmetal oxide containing material to produce the processed lime mud.

23. The method of claim 13, wherein the processed lime mud has a weight median diameter d₅₀ in the range of 0.3 μm to 10 μm.

24. A method for making precipitated calcium carbonate, comprising:
(a) hydrating calcium oxide to form a slake;
(b) adding an aqueous suspension of processed lime mud to the slake; and
(c) adding a carbon dioxide generating material to form an aqueous suspension of precipitated calcium carbonate coated on the processed lime mud, wherein
(i) the addition of the aqueous suspension of the processed lime mud starts and ends before the start of the addition of the carbon dioxide generating material, or
(ii) the addition of the aqueous suspension of the processed lime mud starts before the start of the addition of the carbon dioxide generating material, continues during the addition of the carbon dioxide generating material, and ends on or before pH of a reaction content of step (c) reaches a value of 9 or 10, or
(iii) the addition of the aqueous suspension of the processed lime mud and the addition of the carbon dioxide generating material start at the same time and the addition of the aqueous suspension of the processed lime mud ends on or before pH of a reaction content of step (c) reaches a value of 9 or 10.

25. The method of claim 24, additionally comprising:
(d) separating the precipitated calcium carbonate and processed lime mud from the aqueous suspension; and
(e) drying the separated solids to form dry precipitated calcium carbonate at least partially coated on the processed lime mud.

26. The method of claim 25, wherein a total amount of the processed lime mud used is greater than 0.3 wt % and less than 80 wt % based on the total weight of the dry precipitate calcium carbonate.

27. The method of claim 24, wherein the processed lime mud has a weight median diameter d₅₀ in the range of 0.3 μm to 10 μm.

28. A paper product comprising the precipitated calcium carbonate and processed lime mud made from the process according to claim 1.

29. A filler material comprising precipitated calcium carbonate grow on processed lime mud particles made from the process according to claim 1.

30. The filler material of claim 29, wherein a specific surface area of the filler material is at least 45% less than a specific surface area of a blend of the processed limed mud and PCC when blended after the carbonation process.
